(19) United States
(12) Patent Application Publication
(10) Pub. No.: US 2009/0276819 A1
(43) Pub. Date: Nov. 5, 2009

(54) Method of receiving broadcasting signal and apparatus for receiving broadcasting signal

(76) Inventors: Jin Pil KIM, Seoul (KR); Jong Yeul SUH, Seoul (KR)

Correspondence Address: MCKENNA LONG & ALDRIDGE LLP, 1900 K STREET, NW, WASHINGTON, DC, 20006, US

(21) Appl. No.: 12/453,212

(22) Filed: May 1, 2009

Related U.S. Application Data
(60) Provisional application No. 61/049,780, filed on May 2, 2008.

(51) Int. Cl. H04N 7/173

(52) U.S. Cl. 725/105

(57) ABSTRACT

A method and apparatus for receiving a broadcasting signal for a real-time broadcasting service and a non-real-time broadcasting service are disclosed. The apparatus for receiving the broadcasting signal includes a receiving unit, a storage medium, a first processor and a second processor. The receiving unit receives and displays a broadcasting service in real-time. The first processor receives and decodes non-real-time content based on reception time information and identification information included in first signaling information, and stores the decoded non-real-time content in the storage medium. The second processor reads and presents the non-real-time content from the storage medium based on presentation time information and the identification information included in second signaling information, and displays the broadcasting service in real-time.

This application claims the benefit of Korean Patent Application No. 61/049,780, filed on May 2, 2008, which is hereby incorporated by reference as if fully set forth herein.

### BACKGROUND OF THE INVENTION

1. Field of the Invention

The present invention relates to a method of receiving a broadcasting signal and an apparatus for receiving a broadcasting signal.

2. Discussion of the Related Art

Digital television (DTV) can provide various services in addition to video and audio signals which are the inherent functions of television (TV). For example, DTV can provide an Electronic Program Guide (EPG) or the like to users and can simultaneously provide broadcasting services received from at least two channels. In particular, as an apparatus for receiving a broadcasting signal includes a mass storage device and is connected with a data communication channel or the Internet for realizing bidirectional communication, the number of services which can be provided using a broadcasting signal has been increased.

In such an environment, recently, a method of transmitting or receiving a broadcasting signal, which is capable of providing a service by combining a real-time broadcasting service and a non-real-time broadcasting signal, or an apparatus for receiving a broadcasting signal, which is capable of implementing the method, has been developed.

### SUMMARY OF THE INVENTION

Accordingly, the present invention is directed to a method of receiving a broadcasting signal and an apparatus for receiving a broadcasting signal that substantially obviate one or more problems due to limitations and disadvantages of the related art.

An object of the present invention is to provide a method of receiving a broadcasting signal and an apparatus for receiving a broadcasting signal, which are capable of efficiently providing a combination of a real-time broadcasting service and a non-real-time broadcasting service.

Another object of the present invention is to provide a method and apparatus capable of receiving and storing a non-real-time broadcasting service in a storage medium based on signaling information.

Another object of the present invention is to provide a method and apparatus capable of providing a non-real-time broadcasting service to a user based on signaling information during a real-time broadcasting service.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of processing data in a reception system includes receiving and displaying a broadcasting service in real-time, receiving and storing non-real-time content in a storage medium based on reception time information and identification information included in first signaling information, reading and presenting the non-real-time content from the storage medium based on presentation time information and the identification information included in second signaling information, and displaying the broadcasting service in real-time.

The first signaling information may further include channel information for receiving the NRT content and file associated information of the NRT content.

In another aspect of the present invention, a reception system includes a receiving unit, a storage medium, a first processor, and a second processor. The receiving unit receives and displays a broadcasting service in real-time. The first processor receives and decodes non-real-time content based on reception time information and identification information included in first signaling information, and stores the decoded non-real-time content in the storage medium. The second processor reads and presents the non-real-time content from the storage medium based on presentation time information and the identification information included in second signaling information, and displays the broadcasting service in real-time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram of provision of a real-time (RT) service and a non-real-time (NRT) service;

FIG. 2 is a view showing an example of signaling information necessary for receiving and storing NRT content according to the present invention;

FIG. 3 is a view showing an example of file associated information included in a file descriptor of FIG. 2;

FIG. 4 is a view showing an example of a syntax structure of an Event Information Table (EIT) section for transmitting signaling information according to the present invention;

FIG. 5 is a flowchart illustrating an embodiment of a process of receiving and storing NRT content in a storage medium by referring to signaling information according to the present invention;

FIG. 6 is a view showing an example of a syntax structure of a Content Triggering Table (CTT) section for transmitting signaling information necessary for presenting NRT content according to the present invention;

FIG. 7 is a flowchart illustrating an embodiment of a process of presenting NRT content by referring to the transmitted CTT section shown in FIG. 6;

FIG. 8 is a view showing another example of the syntax structure of the CTT section for transmitting signaling information necessary for presenting NRT content according to the present invention;

FIG. 9 is a flowchart illustrating an embodiment of a process of presenting NRT content by referring to the transmitted CTT section shown in FIG. 8; and

FIG. 10 is a block diagram showing an embodiment of an apparatus for receiving a broadcasting signal according to the present invention.

### DETAILED DESCRIPTION OF THE INVENTION

Reference will now be made in detail to the preferred embodiments of the present invention, examples of which are illustrated in the accompanying drawings. The configuration and operation of the present invention shown in the drawings and described hereinafter will be described in at least one embodiment, without limiting the spirit and scope of the present invention.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

In the present invention, broadcasting content is received via a medium such as terrestrial or cable network in non-real time (NRT) and is stored in a storage medium. For convenience of description, such broadcasting content is called NRT content. In one embodiment of the present invention, the NRT content is stored in the storage medium in a file format. In one embodiment of the present invention, the storage medium is a built-in hard disk drive (HDD) mounted in an apparatus for receiving a broadcasting signal. Alternatively, the storage medium may be a Universal Serial Bus (USB) memory or an external HDD connected to an apparatus for receiving a broadcasting signal.

In the present invention, the NRT content can be presented during a real time or live broadcasting service.

At this time, in order to receive and store the NRT content in the storage medium or present the NRT content stored in the storage medium, signaling information is necessary.

Accordingly, the present invention provides a method of transmitting signaling information for storing and presenting NRT content. In particular, in the present invention, NRT content can be received and stored in a storage medium by referring to signaling information, and NRT content stored in the storage medium can be read and presented during a real-time broadcasting service by referring to the signaling information.

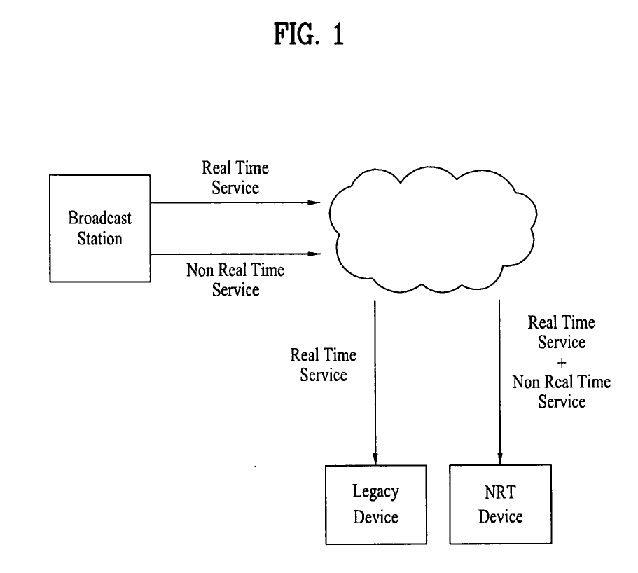

FIG. 1 is a conceptual diagram of provision of a real-time (RT) service and an NRT service.

The NRT service indicates a service for receiving and storing NRT content transmitted in NRT using a portion of a broadcasting channel and, more particularly, a redundant bandwidth of a broadcasting channel, and then providing the NRT content to a user. The transfer rate of the NRT content is low. Accordingly, the NRT content is mainly used for presentation after storage, rather than real-time viewing.

The RT service is a broadcasting service for receiving broadcasting content in RT and providing the broadcasting content to a user, such as a current terrestrial broadcast.

For example, a broadcast station can transmit broadcasting content in RT using an RT service and transmit content for news clips, weather information, advertisement or Push Video On Demand (VOD) in NRT using an NRT service. In addition, the NRT content may be specific scenes of an RT broadcasting stream as well as news clips, weather information, advertisements and Push VOD.

A conventional broadcast receiver (that is, a legacy device) can receive and process an RT service, but cannot receive and process an NRT service.

A broadcast receiver (that is, an NRT device) according to the present invention can provide various services by combining an NRT service and an RT service. At this time, the RT service and the NRT service can be received in an MPEG-2 Transport Stream (TS) format via the same broadcasting channel. In this case, in order to identify the NRT service, a unique Packet Identifier (PID) is allocated to the TS packet of the NRT content for the NRT service. Alternatively, the NRT content for the NRT service may be received in an Internet Protocol (IP) stream format. In one embodiment of the present invention, the content is received in the MPEG-2 TS packet format.

That is, the NRT content is in a file format. A broadcast station packetizes the file according to a file transfer protocol scheme and packetizes the packetized file according to an Asynchronous Layered Coding/Layered Coding Transport (ALC/LCT) scheme. The ALC/LCT packets are packetized according to a User Datagram Protocol (UDP) scheme, and the ALC/LCT/UDP packets are packetized according to an IP scheme, thereby obtaining ALC/LCT/UDP/IP packet data. Then, if the ALC/LCT/UDP/IP packet data is divided into 184-byte segments and a 4-byte MPEG header is added to 184-byte data, 188-byte MPEG-2 TS packets can be obtained. At this time, a value allocated to the PID of the MPEG header is a unique value capable of identifying the TS packets for transmitting the NRT content.

As described above, the NRT content packetized into the MPEG-2 TS packets is transmitted to a broadcast receiver in RT or NRT.

In addition, in order to store the NRT content received in the MPEG-2 TS packet format in a storage medium and present the NRT content using the broadcast receiver, an identifier of the file configuring the NRT content should also be known.

That is, in order to receive an NRT service using the broadcast receiver, announcement for an NRT content file (e.g., A/V stream, executable S/W code, data, etc.) received in NRT is necessary.

In the present invention, the announcement for the NRT content may be performed using the existing table of a Program System Information Protocol (PSIP), or a new table may be defined and the announcement for the NRT content may be performed using this table.

In one embodiment of the present invention, the announcement for the NRT content is performed using an Event Information Table (EIT). The EIT is only exemplary and the announcement for the NRT content may be performed using another table.

In an IP environment, the announcement for the NRT content may be performed using a method such as a Session Description Protocol (SDP) or a Session Announcement Protocol (SAP). Also, in an IP environment, the announcement for the NRT content may be performed using a File Delivery over Unidirectional Transport (FLUTE) session.

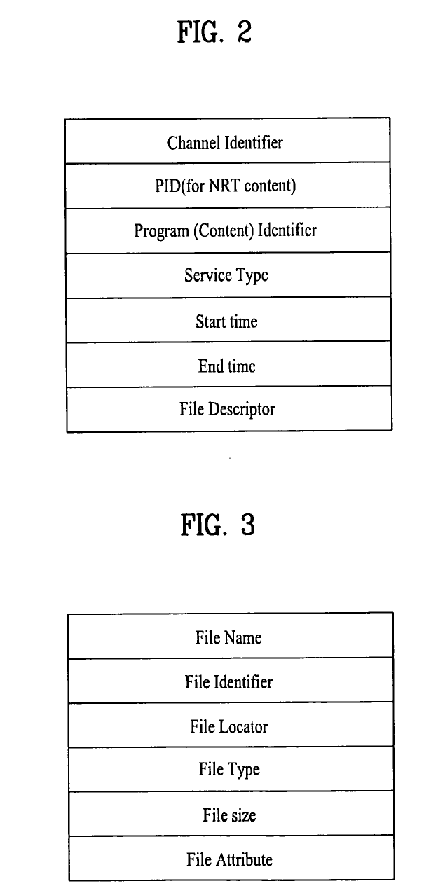

FIG. 2 shows an example of information necessary for announcing the NRT content according to the present invention, that is, signaling information for receiving and storing the NRT content in a storage medium. The signaling information of FIG. 2 includes channel identifier information, PID information for the NRT content, program (content) identifier information, service type information, time information and a file descriptor describing detailed information of a file, in the embodiment of the present invention.

The channel identifier information indicates channel tuning information necessary for receiving the NRT content. That is, in one embodiment of the present invention, the channel identifier information includes channel associated information, such as a major channel number, a minor channel number or a Transport Stream Identifier (TSID).

The PID information is an identifier for discovering TS packets for transmitting the NRT content among TS packets received via a channel indicated by the channel identifier information. In one embodiment of the present invention, a unique PID value is applied such that the TS packets for transmitting the NRT content are identified. Accordingly, in order to discover the NRT content transmitted via the channel, the channel identifier information and the PID value are necessary.

The program (content) identifier information uniquely defines the NRT content file, in order to allow the NRT content to be referenced in any case without restriction for a domain of a channel. That is, when specific NRT content needs to be inserted during an RT (live) broadcast, the NRT content may be referenced using the program identifier information.

In addition, the program identifier information may be used for the management and presentation of the stored NRT content.

The service type information is used to indicate that data is the NRT content file.

In one embodiment of the present invention, the time information includes a start time and an end time. That is, schedule information for transmitting the NRT content file can be known using the start time and the end time. Accordingly, a reception system may store the NRT content in the storage medium using this information. That is, the start time corresponds to a reception start time of the NRT content and an end time corresponds to a reception end time of the NRT content. In another embodiment of the present invention, the time information may include a start time and a duration. Since the end time of the NRT content can be known using the start time and the duration, the NRT content may be stored in the storage medium using this information.

The file descriptor is used to describe the detailed information of the NRT content file.

FIG. 3 is a view showing an embodiment of file associated information included in the file descriptor according to the present invention.

The file descriptor includes basic information of the NRT file. For example, the file descriptor may include at least one of a file name, a file identifier, a file type, a file locator, a file size and a file attribute.

The file identifier is not used in a broadcasting stream domain, but is used in a file processing region. In addition, in one embodiment of the present invention, a unique value is allocated to the file identifier. At this time, the file identifier may be used equally with the program identifier of FIG. 2.

The file type indicates the type of the NRT content file. For example, it is determined whether the NRT content file is an audio/video file using the file type.

In one embodiment of the present invention, the file attribute includes codec information used in the NRT content. If the NRT content is scalable video, the file attribute may include information indicating whether the NRT content is a base layer or an enhancement layer. In addition, the file attribute may include supplementary information such as resolution and frame rate of video.

A transmission system may transmit the signaling information of the NRT content shown in FIGS. 2 and 3 in a state of being included in a Program Map Table (PMT) or an EIT defined in PSI/PSIP or PSI/SI or may define a new table and transmit the signaling information of the NRT content in a state of being included in the new table.

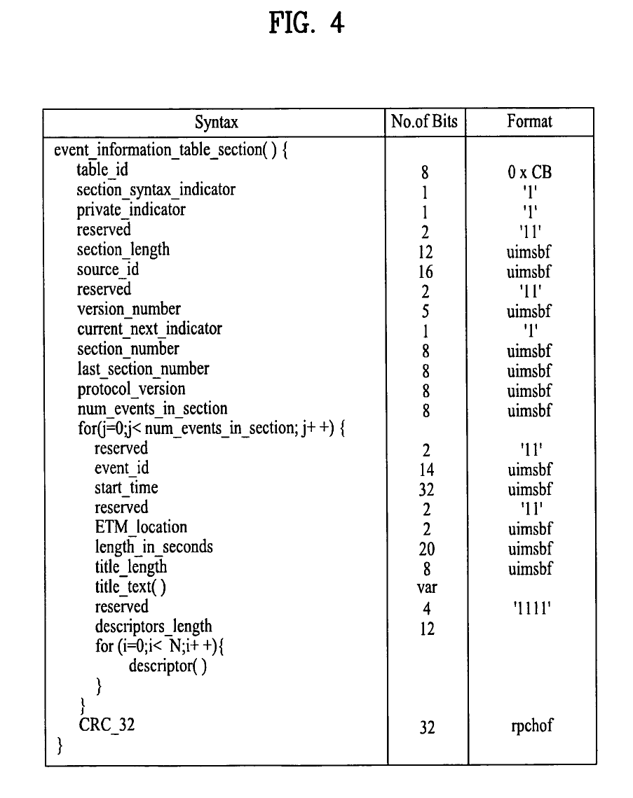

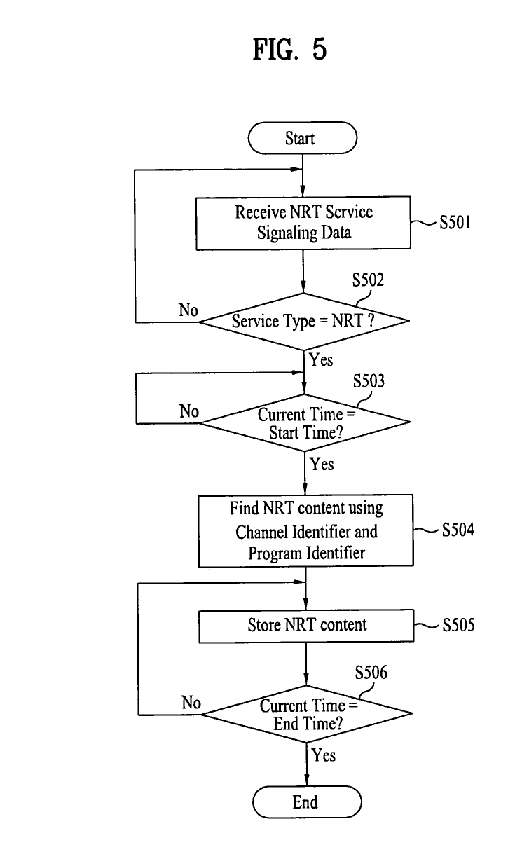

FIG. 4 is a view showing an embodiment of a syntax structure of an EIT section for transmitting the signaling information (that is, announcement information) of the NRT content according to the present invention.

In FIG. 4, a table_id field (8 bits) indicates the identifier of an EIT table section. A section_syntax_indicator field (1 bit) indicates that the EIT uses MPEG long-form syntax.

A private_indicator field (1 bit) is set to 1 in the PSIP.

A reserved field (2 bits) is a reserved region which is set to 11.

A section_length field (12 bits) indicates the length of an EIT section.

A source_id field (16 bits) indicates the identifier of a source associated with the EIT.

A reserved field (2 bits) is a reserved region which is set to 11.

A version_number field (5 bits) indicates the version of the table section, and the value of the version_number field is changed if the content of the table is changed.

A current_next_indicator field (1 bit) indicates whether the EIT section is currently applied or is applied to a next table.

A section_number field (8 bits) indicates the number of sections in which event information is transmitted, that is, the serial number of the section. This value is increased from 0 one by one as the section is increased.

A last_section_number field (8 bits) indicates the last section number of the table section.

A protocol_version field (8 bits) indicates the protocol version of this table section.

A num_events_in_section field (8 bits) indicates the number of events included in the table section.

A reserved field (2 bits) is a reserved region which is set to 11.

An event_id field (16 bits) indicates the identifier of the event to be described. In one embodiment of the present invention, the program identifier of FIG. 2 is allocated to the value of the event_id field.

A start_time field (40 bits) indicates the start time of the event in a Coordinated Universal Time (UTC).

An ETM_location field (2 bits) indicates whether or not an Extended Text Table (ETT) text is applied to a current event.

A length_in_seconds field (20 bits) indicates the duration of the event in seconds.

A title_length field (8 bits) indicates the length of a next string.

A title_text field ( ) indicates the structure of a string in which the title of the event is encoded.

A reserved field (4 bits) indicates a reserved region having 4 bits.

A descriptors_length indicates the length of the following descriptors( ).

In one embodiment of the present invention, if the program identifier of FIG. 2 is allocated to the event_id field, the signaling information (announcement information) of the NRT content shown in FIGS. 2 and 3 is transmitted in a state of being included in the descriptor( ) of the EIT.

FIG. 5 is a flowchart illustrating an embodiment of a process of receiving and storing the NRT content in the storage medium using the signaling information of the NRT content shown in FIG. 2.

In one embodiment of the present invention, the signaling information of the NRT content is received in a state of being included in the EIT.

That is, it is determined whether or not the signaling information of the NRT content is received in a state of being included in the EIT, using the event_id field value of the received EIT. If it is determined that the signaling information of the NRT content is included, the signaling information of the NRT content is extracted from the EIT (S501). If necessary, the extracted signaling information of the NRT content is stored in an internal memory. In this case, for example, the signaling information of the NRT content includes the information shown in FIGS. 2 and 3.

It is determined whether the service type of the extracted signaling information of the NRT content indicates an NRT service (S502). If the service type does not indicate the NRT service in the step S502, the process progresses to the step S501 and the step of receiving the signaling information of the NRT content is performed again.

If the service type indicates the NRT service in the step S502, it is determined whether or not the current time is the start time included in the signaling information of the NRT content (S503). If the current time is not the start time, the process waits until the start time is reached and, if the current time is the start time, the NRT content is received using the channel identifier and the program identifier included in the signaling information of the NRT content (S504). Then, the received NRT content is stored in a storage medium such as a HDD (S505). The storage process continues to be performed until the current time reaches the end time included in the signaling information of the NRT content (S506).

The NRT content stored in the storage medium may be presented at a specific time so as to be provided to a user.

At this time, signaling information for reading and presenting the NRT content stored in the storage medium at a specific time is also necessary.

In one embodiment of the present invention, the NRT content which will be presented at the specific time is determined by a broadcast station. That is, a broadcast receiver which stores the NRT content transmitted in NRT reads and presents the NRT content according to the signaling information for presentation, which is transmitted from the broadcast station.

In one embodiment of the present invention, the broadcast station generates and transmits the signaling information for allowing the broadcast receiver to read and present the NRT content, which is stored in the storage medium in advance, in a specific interval of an RT broadcasting service to the broadcast receiver.

At this time, the signaling information for the presentation of the NRT content may be transmitted in a state of being included in the EIT or the PMT defined in the PSI/PSIP or PSI/SI, or a new table may be defined and the signaling information for presentation of the NRT content may be transmitted in a state of being included in the new table.

In one embodiment of the present invention, the new table is defined and the signaling information for the presentation of the NRT content is transmitted in a state of being included in the new table. In the present invention, this table is called a Content Triggering Table (CTT). That is, the CTT describes the signaling information necessary for allowing the broadcast receiver to present the NRT content file stored in the storage medium of the broadcast receiver in advance in a specific time interval.

In one embodiment of the present invention, the CTT is in MPEG-2 private section format, in order to facilitate the understanding of the present invention. Since any format may be used as the format of the CTT, the present invention is not limited to the above-described embodiment.

The signaling information received using the CTT is information for signaling and announcing the triggering (playback or presentation) of the NRT content using a broadcasting stream. That is, the signaling information received through the CTT is the signaling information of the NRT content which will be presented in a specific interval in place of a live broadcast.

At this time, for example, the number of pieces of NRT content which will be presented in the specific interval in place of the live broadcast is at least one.

In the present invention, if the number of pieces of NRT content which will be presented in the specific interval in place of the live broadcast is two or more, the presentation of the NRT content may be signaled by various methods.

For example, only the total presentation time of all NRT content which will be presented in the specific interval may be signaled or the presentation time of each NRT content may be signaled.

That is, the total presentation time of all the NRT content included in the CTT may be described or the presentation times of each NRT content included in the CTT may be described.

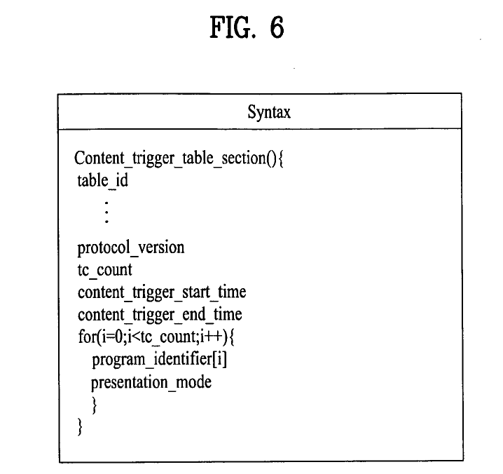

FIG. 6 shows an embodiment of the syntax structure of the CTT section according to the present invention, that is, the syntax structure describing the total presentation time of all the NRT content included in the CTT section.

In FIG. 6, the CTT section is largely divided into a header and a payload. The header corresponds to a table_id field to a protocol_version field. The fields of the header have the same structure and meaning as the fields of the EIT section of FIG. 4 and thus are not shown and described herein.

In FIG. 6, the table_id field of the header has, for example, 8 bits, and a unique identifier capable of identifying a content triggering table section is allocated to the table_id field. In Open Mobile Alliance Mobile Broadcast Service Enabler Suite (OMA BCAST) and International Program for the Development of Communication (IPDC), the table_id field indicates the identifier of a session or message for sending the announcement information.

The protocol_version field indicates the protocol version of the CTT section.

In FIG. 6, the payload includes a tc_count field, a content_trigger_start_time field, a content_trigger_end_time field, and a repetition statement which is repeated by the value of the tc_count field. The repetition statement includes a program_identifier field and a presentation_mode field.

The CTT section of FIG. 6 includes the signaling information for presenting at least one piece of NRT content.

The tc_count field indicates the number of pieces of NRT content which is referenced in the current CTT section, that is, the number of pieces of NRT content which will be presented in the specific interval in place of the live broadcast.

The content_trigger_start_time field indicates the start time of the presentation of the NRT content file, that is, indicates the start time of the replaced interval when the NRT content file is displayed in place of the live broadcast.

The content_trigger_end_time field indicates the end time of the presentation of the NRT content file. After this time, the NRT content file is switched to the live broadcast. That is, the content_trigger_end_time field indicates the end time of the replaced interval. At least one piece of NRT content is presented in the replaced interval.

The content_trigger_end_time may be optional. That is, the NRT content may be presented using only the content_trigger_start_time field and the program_identifier field.

In addition, in order to specify the presentation time of the NRT content, a content_trigger_duration field may be used instead of the content_trigger_end_time field. The presentation time of at least one piece of NRT content may be represented in seconds.

That is, the content_trigger_duration field indicates the total presentation time of the specific interval when at least one NRT content file is displayed in place of the live broadcast in the specific interval from the time corresponding to the value of the content_trigger_start_time field to the value of the content_trigger_end_time field.

The program_identifier field and the presentation_mode field are repeated by the value of the tc_count field so as to indicate the program identifier and the presentation mode of each NRT content.

That is, the program_identifier field indicates the identifier of the NRT content file which will be presented during the presentation time from the value of the content_trigger_start_time field to the value of the content_trigger_end_time field.

The NRT content file to be presented may be referenced using the program_identifier field, and a plurality of NRT content files may be specified. At the time, when the plurality of NRT content files, which are corresponded to the tc_count field value exist, the NRT content of program_identifier extracted first among the plurality of program_identifiers is selected first. More specifically, if the NRT content is not stored in the broadcast receiver, the NRT content of the program_identifier extracted next is selected. This processes are repeated on the remaining NRT contents.

The presentation_mode field indicates the presentation mode of each of the NRT files. For example, if the presentation of the actual NRT file is completed earlier than the time defined in the content_trigger_end_time field, it is indicated whether the file is repeatedly presented or is switched to the live broadcast.

The broadcast receiver may perform the following operation according to the value of the presentation_mode field.

If the value of the presentation_mode field is 0, the NRT content is presented only during a predetermined time. For example, if the presentation time indicated in the CTT is longer than that of the actual NRT content, the presentation of the NRT content file is completed earlier than the presentation time indicated in the CTT and the file is switched to the live broadcast.

If the value of the presentation_mode field is 1, the NRT content is repeatedly presented during a predetermined time. That is, the NRT content is repeatedly presented until the time defined in the content_trigger_end_time field is reached.

If the value of the presentation_mode field is 2, the NRT content is presented in a state in which the current live broadcast is not interrupted but is embedded. For example, the live broadcast and the NRT content are simultaneously displayed using a simultaneous screen function, such as Picture In Picture (PIP), Picture Of Picture (POP), or a double window.

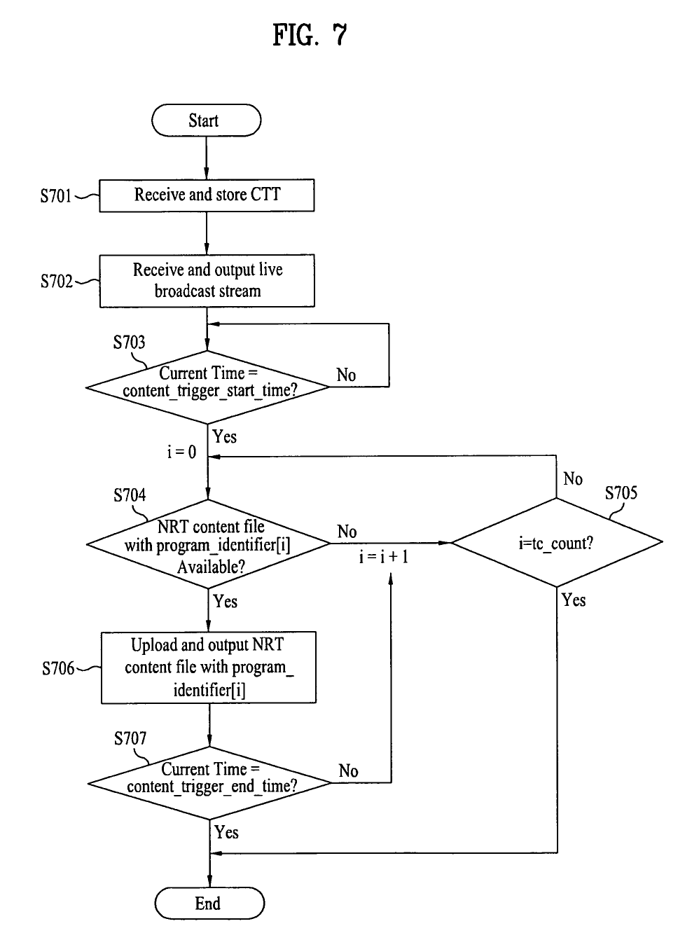

FIG. 7 is a flowchart illustrating an embodiment of a method of uploading and presenting the NRT content stored in the storage medium by referring to the received signaled CTT, as shown in FIG. 6.

First, the CTT shown in FIG. 6 is received and stored (S701). A live broadcast stream is also received and processed and is output to a display device (S702).

Then, while the live broadcast is displayed, it is determined whether or not the current time is the time indicated by the value of the content_trigger_start_time field included in the CTT (S703).

In the step S703, if it is determined that the current time is the time indicated by the value of the content_trigger_start_time field included in the CTT, it is determined whether or not the NRT content is available (S704). In one embodiment of the present invention, if the NRT content corresponding to a program_identifier[i] is stored in the storage medium, it is determined that the NRT content is available.

If it is determined that the NRT content is not available in the step S704, the value i is increased and, if the increased value i is not equal to the tc_count value (S705), the method progresses to the step S704 to determine whether or not the NRT content corresponding to a next program_identifier[i] is available.

If it is determined that the increased value i is equal to the tc_count value, it is indicated that the presentation of all the NRT content included in the CTT is completed. At this time, the NRT content referenced in the CTT are repeatedly presented or the presentation of the NRT content may be completed, according to the value of the presentation_mode field and the value of the content_trigger_end_time field.

If it is determined that the NRT content is available in the step S704, the NRT content is uploaded from the storage medium and is presented (S706). In one embodiment of the present invention, the identifier used when the NRT content is read from the storage medium is the program_identifier.

While the NRT content is presented, it is determined whether or not the current time is the time indicated by the value of the content_trigger_end_time field included in the CTT (S707).

If it is determined that the current time is not the time indicated by the value of the content_trigger_end_time field included in the CTT in the step S707, the value i is increased and the method progresses to the step S705.

If it is determined that the current time is the time indicated by the value of the content_trigger_end_time field included in the CTT in the step S707, the presentation of the NRT content is completed and the NRT content is switched to the live broadcast.

The presentation time information included in the CTT of FIG. 6 is the information about the time for presenting all the NRT content included in the CTT. That is, as shown in FIG. 7, the NRT content included in the CTT is sequentially read from the storage medium and is presented during the time indicated by the content_trigger_start_time field and the content_trigger_end_time field.

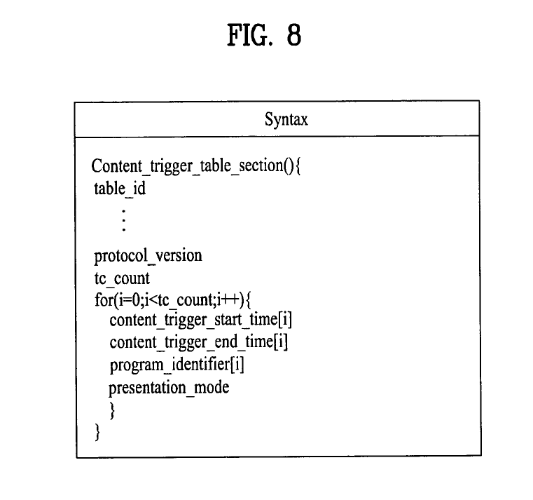

FIG. 8 is a view showing another embodiment of the syntax structure of the CTT section according to the present invention, that is, the syntax structure describing the presentation time of each NRT content included in the CTT section. Even in FIG. 8, a header of the CTT corresponds to a table_id field to a protocol_version field. The fields of the header have the same structure and meaning as the fields of the EIT section of FIG. 4 and thus are not shown and described herein.

A unique identifier capable of identifying a CTT table section is allocated to the table_id field of FIG. 8.

In FIG. 8, in order to describe the presentation time of each NRT content, a content_trigger_start_time field, a content_trigger_end_time field, a program_identifier field and a presentation_mode field are included in a repetition statement repeated by the value of the tc_count field.

The tc_count field indicates the number of pieces of NRT content which is referenced in the current CTT section, that is, the number of pieces of NRT content which will be presented in the specific interval in place of the live broadcast.

The content_trigger_start_time field and the content_trigger_end_time field indicate the presentation start time and the presentation end time of the NRT content corresponding to a program_identifier[i], respectively.

Even in FIG. 8, the content_trigger_end_time field is optional. That is, the NRT content may be presented using only the content_trigger_start_time field and the program_identifier field.

In addition, in order to specify the presentation time of the NRT content, a content_trigger_duration field may be used instead of the content_trigger_end_time field. The presentation time of the NRT content identified by the program_identifier may be represented in seconds.

The program_identifier field and the presentation_mode field indicate the program identifier and the presentation mode of each NRT content, respectively.

The NRT content file to be presented may be referenced using the program_identifier field, and a plurality of NRT content files may be specified. At the time, when the plurality of NRT content files, which are corresponded to the tc_count field value exist, the NRT content of program_identifier extracted first among the plurality of program_identifiers is selected first. More specifically, if the NRT content is not stored in the broadcast receiver, the NRT content of the program_identifier extracted next is selected. This processes are repeated on the remaining NRT contents.

The presentation_mode field indicates the presentation mode of each of the NRT files, and the detailed description thereof is similar to the description of FIG. 6 and thus will be omitted.

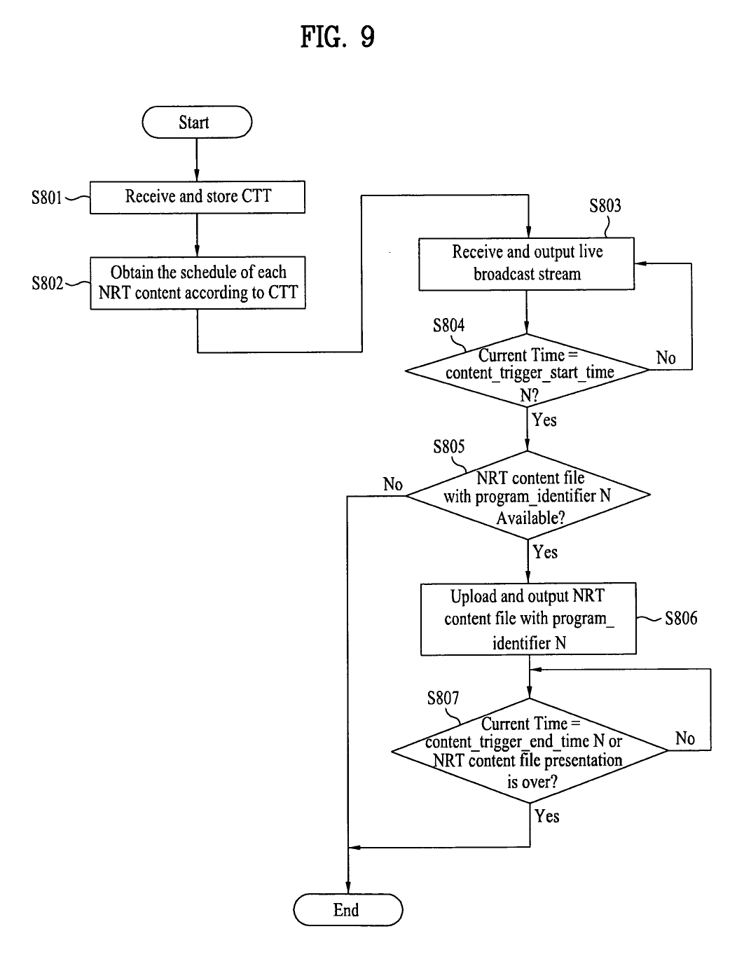

FIG. 9 is a flowchart illustrating an embodiment of a method of uploading and presenting the NRT content stored in the storage medium by referring to the received signaled CTT, as shown in FIG. 8.

FIG. 9 is a flowchart illustrating a process of presenting NRT content according to the value of the content_trigger_start_time field and the value of the content_trigger_end_time field represented in the NRT content units.

First, the CTT shown in FIG. 8 is received and stored (S801). The schedule information of the NRT content included in the CTT, that is, presentation time information, is obtained (S802).

A live broadcast stream is also received and processed and is displayed on a display device (S803).

While the live broadcast is displayed, it is determined whether or not the current time is the time indicated by the value of the content_trigger_start_time field included in an N^{th} NRT content included in the CTT (S804). That is, FIG. 9 shows a process of presenting the N^{th} NRT content by referring to the presentation time of the N^{th} NRT content when it is assumed that N pieces of NRT content are included in the CTT.

If it is determined that the current time is the time indicated by the value of the content_trigger_start_time field included in the N^{th} NRT content included in the CTT in the step S804, it is determined whether or not the N^{th} NRT content is available (S805). In one embodiment of the present invention, if the NRT content corresponding to a program_identifier N is stored in the storage medium, it is determined that the NRT content is available.

If it is determined that the NRT content is not available in the step S805, the signaling information of the CTT is ignored and the NRT content is switched to the live broadcast service, in one embodiment of the present invention.

If it is determined that the NRT content is available in the step S805, the N^{th} NRT content is uploaded from the storage medium and is presented (S806). In one embodiment of the present invention, the identifier used when the N^{th} NRT content is read from the storage medium is the program_identifier N.

While the N^{th} NRT content is presented, it is determined whether or not the current time is the time indicated by the value of the content_trigger_end_time field of the N^{th} NRT content included in the CTT or whether or not the presentation of the NRT content is completed (S807).

If it is determined that the current time is the time indicated by the value of the content_trigger_end_time field of the N^{th} NRT content included in the CTT or it is determined that the presentation is completed in the step S807, the NRT content is switched to the live broadcast service.

In one embodiment of the present invention, the above-described CTT according to the present invention is periodically transmitted to the broadcast receiver before the presentation start time of the NRT content indicated by the CTT. That is, the CTT is periodically transmitted to the broadcast receiver before the time indicated by the content_trigger_start_time field of the CTT.

In the OMA BCAST or IPDC, a notification scheme defined by each of the methods is used and the above-described signaling information is transmitted in an Extensible Markup Language (XML) format.

Even while the live broadcast is being recorded, the replaced interval in which the live broadcast is replaced by the NRT content is identified using the CTT. For example, the replaced interval may be identified using the presentation time information and the current time information of the CTT. During the identified replaced interval, the live broadcast is not recorded, but the location information (that is, reference information, index information or address information) of the storage medium for storing the NRT content to be presented in the replaced interval is stored. That is, when the recorded live broadcast is presented, the NRT content is presented in the replaced interval, in place of the live broadcast. At this time, since the NRT content is stored in the storage medium in advance, only the location information of the NRT content is stored together with the live broadcast signal.

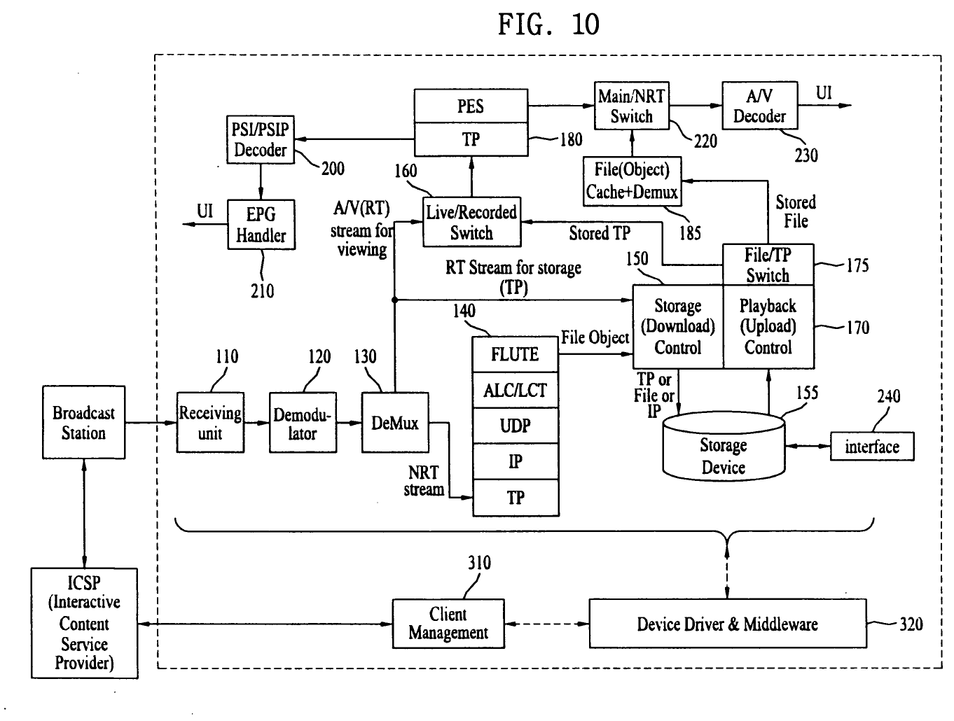

FIG. 10 is a block diagram showing an embodiment of an apparatus for receiving a broadcasting signal, which is capable of receiving, storing and presenting NRT content in NRT.

The embodiment of the apparatus for receiving the broadcasting signal includes a receiving unit 110, a demodulator 120, a demultiplexer 130, a file decoder 140, a storage controller 150, a storage medium 155, a first switch 160, a playback controller 170, a second switch 175, a packet processor 180, a temporary storage unit 185, a data decoder 200, a guide information handler 210, a third switch 220, an audio/video (A/V) decoder 230, an interface 240, a manager 310 and a controller 320.

The receiving unit 110 tunes to a broadcasting signal of a desired channel among broadcasting signals received, for example, using terrestrial waves. The receiving unit 110 may receive a real-time stream and a non-real-time stream. In the present invention, the non-real-time stream is called an NRT stream.

The demodulator 120 demodulates the received broadcasting signal of the channel, performs a Vestigial Side Band (VSB) demodulating process if the broadcasting signal is a VSB modulation signal, and outputs the demodulated signal to the demultiplexer 130 in a stream format.

The demultiplexer 130 outputs the stream to the file decoder 140 if the demodulated stream is an NRT stream, outputs the stream to the storage controller 150 if the demodulated stream is an RT stream for storage, and outputs the stream to the first switch 160 if the demodulated stream is an RT A/V stream for viewing. At this time, in one embodiment of the present invention, the demultiplexer 130 demultiplexes the stream using the PID value. The first switch 160 selects one of TP streams uploaded from the storage medium 155 and the RT A/V stream for viewing and outputs the selected stream to the packet processor 180.

The file decoder 140 may decode the NRT content file from the received NRT stream. The NRT stream may be transmitted in a TS packet format, an IP packet format or a file format. In one embodiment of the present invention, the NRT content having a file structure is received in the TS packet format.

Accordingly, the file decoder 140 receives the NRT stream, removes an MPEG header from a TP layer, removes an IP-header from an IP layer, removes an UDP header from an UDP layer, removes an ALC/LCT header from an ALC/LCT layer, and applies a file transfer protocol, thereby decoding a file object configuring the NRT content file. The file object is directly output to the storage controller 150.

The storage controller 150 stores the file object in the storage medium 155 by referring to the signaling information shown in FIGS. 2 and 3. In one embodiment of the present invention, the storage medium 155 is a built-in HDD.

The signaling information shown in FIGS. 2 and 3 may be received using a new table or a table such as an EIT. The table for transmitting the signaling information is output to the data decoder 200 through the demultiplexer 130, the first switch 160 and the packet processor 180 and is decoded by the data decoder. The signaling information of the table decoded by the data decoder 200 may be stored in the built-in memory (not shown) or the storage medium 155 and, if necessary, may be provided to a user using the guide information (e.g., EPG) handler 210. For example, the data decoder 200 collects the sections having the same table identifier table_id, configures and parses the table, and stores the parsed result in the built-in memory or provides the parsed result to the user.

If the signaling information for receiving and storing the NRT content according to the present invention is received in a state of being included in the EIT, the data decoder 200 decodes the EIT and acquires the signaling information. The acquired signaling information is stored so as to be used to receive and store the NRT content. The signaling information include channel information for receiving the NRT content and identification information for identifying the NRT content as shown in FIGS. 2 and 3.

The storage controller 150 stores the file object output from the file decoder 140 in the storage medium 155 by referring to the signaling information extracted from the EIT.

In addition, the storage controller 150 receives the RT stream for storage output from the demultiplexer 130 and stores the RT stream in the storage medium 155.

The playback controller 170 reads the file object configuring the TP stream and the NRT content stored in the storage medium 155 and outputs the file object to the second switch 175.

That is, the CTT for transmitting the signaling information referred to when the NRT content according to the present invention is presented is decoded by the data decoder 200. In one embodiment of the present invention, the signaling information extracted from the decoded CTT is output to the playback controller 170.

The playback controller 170 reads the NRT content stored in the storage medium 155 and presents the NRT content during a predetermined presentation time, by referring to the signaling information extracted from the CTT during the live broadcast.

In one embodiment of the present invention, the presentation time information (e.g., the content_trigger_start_time field and the content_trigger_end_time field) is received in a state of being included in the CTT. In addition, in one embodiment of the present invention, the identification information (e.g., the program_identifier field) of the NRT content to be presented during the live broadcast is received in a state of being included in the CTT.

That is, in one embodiment of the present invention, the NRT content to be presented during the live broadcast and the presentation time of the NRT content are determined by the broadcast station.

The second switch 175 outputs data to the A/V decoder 230 through the temporary storage unit 185 and the third switch 220 if the data read from the storage medium 155 is the NRT content file.

The temporary storage unit 185 temporarily stores the NRT content file in order to easily upload the NRT content file to the A/V decoder 230. In particular, the temporary storage unit 185 may cache the NRT content to be uploaded in advance by referring to the signaling information, in order to prevent the NRT content from being uploaded from the storage medium 155 without having time to spare.

The second switch 175 outputs data to the packet processor 180 through the first switch 160 if the data read from the storage medium 155 is the TS packet.

That is, the RT stream demultiplexed by the demultiplexer 130 or the TS packet uploaded by the playback controller 170 is input to the packet processor 180 through the first switch 160.

The packet processor 180 removes the TS header and outputs the TS packet to the data decoder 200 if the TS packet is the table information such as PSI/PSIP, and removes the TS header, configures a Packetized Elementary Stream (PES), and outputs the PES to the A/V decoder 230 through the third switch 220 if the TS packet is A/V data.

The A/V decoder 230 decodes the live broadcasting stream selectively output from the third switch 220 or the A/V stream included in the NRT content file using a decoding algorithm and outputs the decoded stream.

The interface 240 receives and processes various control signals from the user. For example, the interface 240 may receive NRT content selection information selected by the user and store the user selection information.

The manager 310 may communicate with a content service provider by an interactive protocol such as an Internet protocol, and receive an Internet broadcast from the content service provider in RT or NRT.

The controller 320 may control the components of the broadcasting signal receiving apparatus including the manager 310 and operate middleware for providing the broadcasting service.

According to the method of receiving the broadcasting signal and the apparatus for receiving the broadcasting signal of the present invention, it is possible to efficiently provide a combination of an RT broadcasting service and an NRT broadcasting service.

In addition, according to the present invention, it is possible to allow the broadcast receiver to seamlessly present the NRT content stored in advance using replaceable interval information and realize a targeted advertising service and content switching in a receiver such as a digital TV receiver or an IPTV receiver.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing data in a reception system, the method comprising:
receiving and displaying a broadcasting service in real-time;
receiving and storing non-real-time content in a storage medium based on reception time information and identification information included in first signaling information;
reading and presenting the non-real-time content from the storage medium based on presentation time information and the identification information included in second signaling information; and
displaying the broadcasting service in real-time.

2. The method according to claim 1, wherein the first signaling information further includes channel information for receiving the non-real-time content and file associated information of the non-real-time content.

3. The method according to claim 1, wherein the first signaling information is received in a state of being included in an event information table (EIT).

4. The method according to claim 1, wherein the second signaling information is received in a state of being included in a Content Triggering Table (CTT).

5. The method according to claim 4, wherein the CTT includes the number of pieces of non-real-time content referenced in the CTT, total presentation time information of the non-real-time content referenced in the CTT, and program identification information applied to each non-real-time content referenced in the CTT.

6. The method according to claim 5, wherein the CTT further includes presentation mode information indicating whether at least one piece of non-real-time content is repeatedly presented or the broadcasting service in real-time is displayed according to the total presentation time information.

7. The method according to claim 4, wherein the CTT includes the number of pieces of non-real-time content referenced in the CTT, presentation time information applied to each non-real-time content referenced in the CTT, program identification information applied to each non-real-time content referenced in the CTT.

8. The method according to claim 7, wherein the CTT further includes presentation mode information indicating whether a corresponding non-real-time content is repeatedly presented or the broadcasting service in real-time is displayed according to the presentation time information of the non-real-time content.

9. The method according to claim 4, wherein the CTT is periodically received before a presentation time included in the CTT.

10. A reception system comprising:
a receiving unit receiving and displaying a broadcasting service in real-time;
a storage medium;
a first processor receiving and decoding non-real-time content based on reception time information and identification information included in first signaling information, and storing the decoded non-real-time content in the storage medium; and
a second processor reading and presenting the non-real-time content from the storage medium based on presentation time information and the identification information included in second signaling information, and displaying the broadcasting service in real-time.

11. The reception system according to claim 10, wherein the first signaling information further includes channel information for receiving the non-real-time content and file associated information of the non-real-time content.

12. The reception system according to claim 10, wherein the first signaling information is received in a state of being included in an event information table (EIT).

13. The reception system according to claim 10, wherein the second signaling information is received in a state of being included in a Content Triggering Table (CTT).

14. The reception system according to claim 13, wherein the CTT includes the number of pieces of non-real-time content referenced in the CTT, total presentation time information of the non-real-time contents referenced in the CTT, program identification information applied to each non-real-time content referenced in the CTT, and presentation mode information indicating whether at least one piece of non-real-time content is repeatedly presented or the broadcasting service in real-time is displayed according to the total presentation time information.

15. The reception system according to claim 13, wherein the CTT includes the number of pieces of non-real-time content referenced in the CTT, presentation time information applied to each non-real-time content referenced in the CTT, program identification information applied to each non-real-time content referenced in the CTT, and presentation mode information indicating whether a corresponding non-real-time content is repeatedly presented or the broadcasting service in real-time is displayed according to the presentation time information of the non-real-time content.
